(19) United States
(12) Patent Application Publication
(10) Pub. No.: US 2009/0234659 A1
(43) Pub. Date: Sep. 17, 2009

(54) SPATIAL AND TEMPORAL TWO-DIMENSIONAL SCHEDULING METHOD AND SYSTEM THEREOF

(76) Inventors: Shang-I Liao, Taipei City (TW); Shao-Ting Lee, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/046,466

(22) Filed: Mar. 12, 2008

(51) Int. Cl. G06Q 99/00

(52) U.S. Cl. 705/1

(57) ABSTRACT

A method of event scheduling includes scheduling an event having an event time and an event location; determining a position of the user prior to the event; calculating a travel time required before the event according to the event location and the position of the user prior to the event; and reminding the user of the event according to the travel time before the event time.

### BACKGROUND OF THE INVENTION

1. Field of the Invention

The present invention relates to a two-dimensional scheduling method and system, and more particularly, to a spatial and temporal two-dimensional scheduling method and system thereof.

2. Description of the Prior Art

The modern pace of life has put many of us into the fast lane, so to speak, with our daily lives becoming more and more dictated by meetings and schedules, both work related and personal. Being that time is becoming increasingly precious in our busy lives, so too should more intelligent scheduling methods and systems to help better manage our time.

A traditional and common approach to managing time exists in today's calendar or date book, or an electronic version of it, such as Microsoft Outlook and Apple iCal. Such electronic scheduling systems are popular now as they provide their users with a solution for scheduling meetings and activities. Groups of users can share and exchange calendars with each other based on standard calendar formats such as the vCalendar and iCalendar formats, an example of the former being shown in FIG. 1.

Common to calendar system implementations is the ability to remind a user with alarms, be they visually, audibly, and/or in other fashions. Normally, alarms for calendar events are manually set to be a certain preferred time before the event is to begin, allowing the user ample notice to prepare or to remember the specific event. Please refer to FIG. 2, which shows a timeline 200 with an event 210 in the concept of a common calendar. The event 210 has a start time 220 and an end time 230, and an alarm 240 is set. In the example of FIG. 2, for instance, a businessperson may hear the alarm ring at 10:45 am for the hour-long business meeting to attend at 11:00.

As our schedules become more demanding, however, we are constantly required to react to fast-paced and last-minute changes. And while our portable electronic devices grow more intelligent and more capable, users deserve an innovative new method to better manage their time.

### SUMMARY OF THE INVENTION

It is therefore an objective of the present invention to solve the aforementioned problems, and to provide a spatial and temporal two-dimensional scheduling method and system thereof.

According to an exemplary embodiment of the present invention, a method of event scheduling is disclosed comprising scheduling an event having an event time and an event location; determining a position of the user prior to the event; calculating a travel time required before the event according to the event location and the position of the user prior to the event; and reminding the user of the event at least the travel time before the event time.

These and other problems are generally solved or circumvented, and technical advantages are generally achieved, by advantageous embodiments of the present invention, which includes the method determining the position of the user prior to the event as the current location of the user according to a Global Navigation Satellite Systems (GNSS) module.

In other embodiments, the method calculates the travel time is performed according to real-time traffic information, according to a user profile specifying travel preferences for the user, or according to historical user data including how long the user required to travel to such events in the past.

Yet another embodiment of the invention comprises scheduling a plurality of events, where each event having a respective event time and event location; determining a position of the user prior to each event; calculating a travel time required before each event according to the respective event location of each event and the position of the user prior to each event; and reminding the user of each event at least the travel time before each event.

A scheduling system embodiment of the invention comprises a calendar database for scheduling a plurality of events, each event having a respective event time and event location; a geographic information system (GIS) navigating system for determining a position of the user prior to each event; a spatial and temporal 2D validation module for calculating a travel time required before each event according to the respective event location of each event and the position of the user prior to each event; and a real-time calendar check module for reminding the user of each event at least the travel time before each event.

An embodiment further comprises determining an order of the events according to at least one scheduling factor; automatically scheduling the events according to the determined order of events; and reminding the user according to the travel time of each event. In this embodiment, the scheduling factor can comprise a total travel time required between the events within a predetermined period according to the event location of each event, and can schedule a suggested event time for each event according to the order of events and the at least one scheduling factor.

The foregoing has outlined rather broadly the features and technical advantages of the present invention in order that the detailed description of the invention that follows may be better understood. Additional features and descriptions of the present invention will be described hereinafter which form the subject of the claims of the present invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an example of an event according to a vCalendar format.

FIG. 2 is a timeline showing an event and an alarm in a common “one-dimensional” calendar.

FIG. 3 is a flowchart of a method according to the present invention.

FIG. 4 is a graph showing an event and an alarm for a “two-dimensional” calendar according to an embodiment of the present invention.

FIG. 5 is a diagram depicting various exemplary locations of events according to a schedule in an embodiment of the present invention.

FIG. 6 is a flowchart of a calendar spatial check according to one embodiment of the present invention.

FIG. 7 is a flowchart of a calendar real-time alarm check according to one embodiment of the present invention.

FIG. 8 is a block diagram illustrating an example process according to an embodiment of the present invention.

FIG. 9 is a system block diagram illustrating a “two-dimensional” scheduling system according to an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

As mentioned, our daily schedules are becoming more demanding, and users deserve an innovative new method to better manage their time, such as a spatial and temporal two-dimensional scheduling method and calendar system implementing such a method.

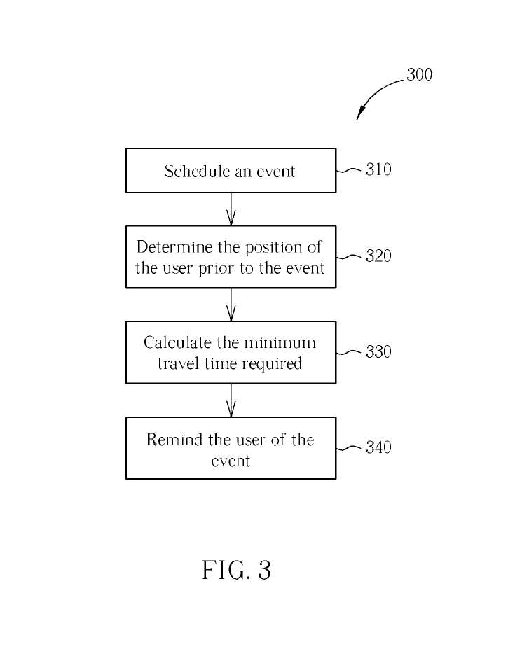

Please refer to FIG. 3, which shows a method of scheduling an event according to an embodiment of the present invention. Provided that substantially the same result is achieved, the steps of the process flowchart 300 need not be in the exact order shown and need not be contiguous; that is, other steps can be intermediate. The embodiment of the method according to the present invention includes the following steps:
Step 310: Schedule an event having an event time and an event location.
Step 320: Determine the position of the user prior to the event.
Step 330: Calculate the travel time required before the event according to the event location and the position of the user prior to the event.
Step 340: Remind the user of the event at least the travel time before the event time.

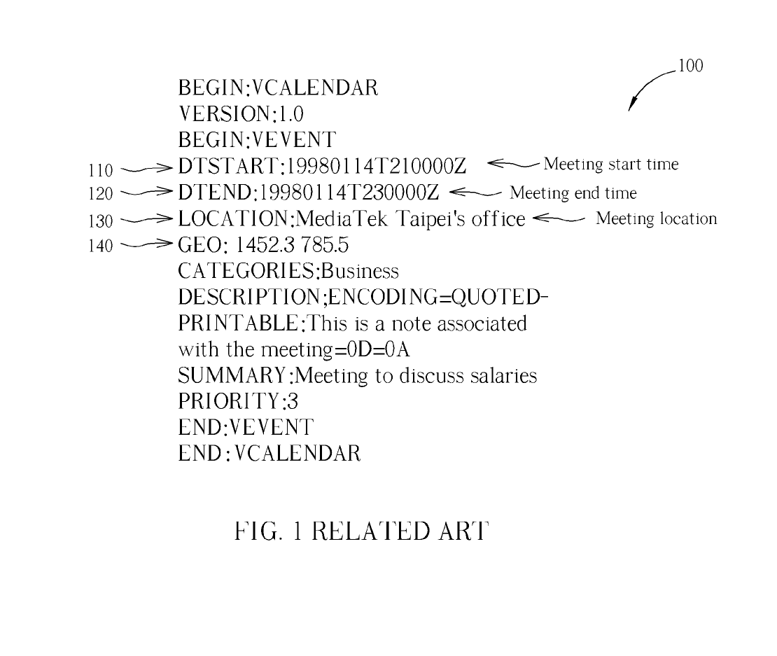

In Step 310, an event is scheduled with an event time and an event location. (It should be noted that the scheduling step (310) presumably includes a method of storing the scheduled event and/or manipulating event data for later retrieval, but this should already be obvious to persons of ordinary skill in the field.) Turning our attention back to FIG. 1 briefly, the example of a vCalendar event 100 shows a number of fields providing information important to scheduling events both temporally (time) and spatially (location). In FIG. 1, the event 100 includes a start time 110 and an end time 120 denoting the beginning and ending times of the event, a location 130 describing the location of the event, and a geographical location 140 giving more detailed or precise location information. Other fields also exist within the calendar format, but are not specifically marked because they are not the focus of the present invention. (Please note that it is not required by most calendar systems to have all fields populated, and as such, some of the above may be left empty.) In particular, the location 130 and geographical location 140 of the event can be combined provide a number of different types of location data. As an example, a longitude and latitude coordinate pair can be entered into the geographical location 140, such as “20.97, 156.83”. Another example is where the location 130 contains the name of a popular Point of Interest (POI) such as “Taipei 101”, or a street address like “1 Infinite Loop Cupertino, Calif. 95014”. In a normal application, the event location 130 can also hold a less descriptive note, such as “7^{th} floor meeting room”. Usually associated with the event 100, of course, is also an event name.

When an event has been scheduled into the calendar using this scheduling method, the method's next step determines the position of the user prior to the event. Determining the position of the user prior to the event can take many forms, the simplest of which is to assume the user's location directly before the event is the same location as an event that is immediately (or most closely) preceding the event in question. For example, when an event 210 is set at 11:00 am and another event is set to start at 9:30 am and end at 10:30 am, the method can determine that the user's logical position before the event 210 would be substantially the same location as the immediately preceding event.

A more preferable embodiment of Step 320, however, is to determine the position of the user prior to the event by determining a current location of the user with a Geographic Information System (GIS) device. This GIS device can be a Global Navigation Satellite System (GNSS) device, such as a Global Positioning System (GPS) unit, and the unit can be integrated with the system comprising the scheduling method. For example, the scheduling method in one embodiment can be implemented into a mobile phone with calendar functions that also has an integrated GNSS module. In such an embodiment, the GNSS position reading would provide a more accurate, up-to-date input of the current location of the user for Step 330. (When utilizing a GNSS module, a modification to the manner of entering event location above is also possible: the device could allow the user to indicate a location from an electronic map, and for the device to then process the location chosen.)

Utilizing the determined position of the user prior to the scheduled event, Step 330 calculates the travel time required to reach the event location; this calculated travel time is based both on the location of the event and the position of the user prior to that event. When the position of the user prior to the event is the location of another event preceding this event, then the travel time required can be precalculated (e.g., when the event has just been scheduled, which may be some hours, days, or even weeks before the occurrence of the event). When the current position of the user prior to the event is obtained from a GNSS module (as mentioned above), the travel time required to reach the event location can be continually updated based on the latest determined position of the user, as the event location and time approach. In addition, the GIS device can calculate the travel time required based on a determined route between the current position and the event location.

In a further enhanced embodiment of the calculating step 330, the travel time is calculated not only according to the user's current position relative to the event location, but also based on recent or real-time traffic information obtained by the wireless network contained in the system. In this manner, the scheduling method takes into account the actual traffic time needed to reach the next event location based on current conditions. An obvious extension of this embodiment (after reading the above) is to accommodate weather conditions as well as knowledge or schedules of other events such as concerts, sports events, or festivals, which can all affect the travel time required.

Another embodiment for calculating the travel time required also utilizes travel preferences in the user profile to provide additional factors. One example of such an implementation would be, say, the user seems to always take 10% longer to reach the event destinations than the travel time estimates; in this case, the scheduling method adapts knowledge of the user's history and preferences when estimating future travel times required. Another example is where the user prefers to take smaller roads and avoid highways, or wishes to avoid toll streets. There are, of course, numerous adaptations to these embodiments of calculating a more realistic and/or accurate travel time estimate, which will no doubt become apparent after reading the above disclosure; those shall also be considered to be within the scope of the invention.

Once the travel time required has been calculated in Step 330, Step 340 reminds the user of the event according to the travel time before the scheduled event time. In the running example, the event 210 starts at 11:00 am, and let's assume the calculated travel time required is one-half hour (30 minutes). The reminder for the user would then come at least 30 minutes before 11:00 am, allowing the user sufficient time to arrive at the predetermined event location on time.

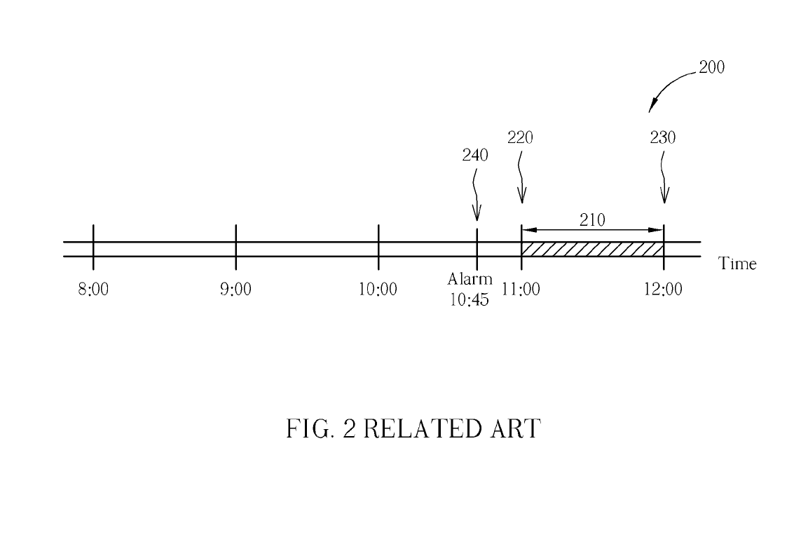

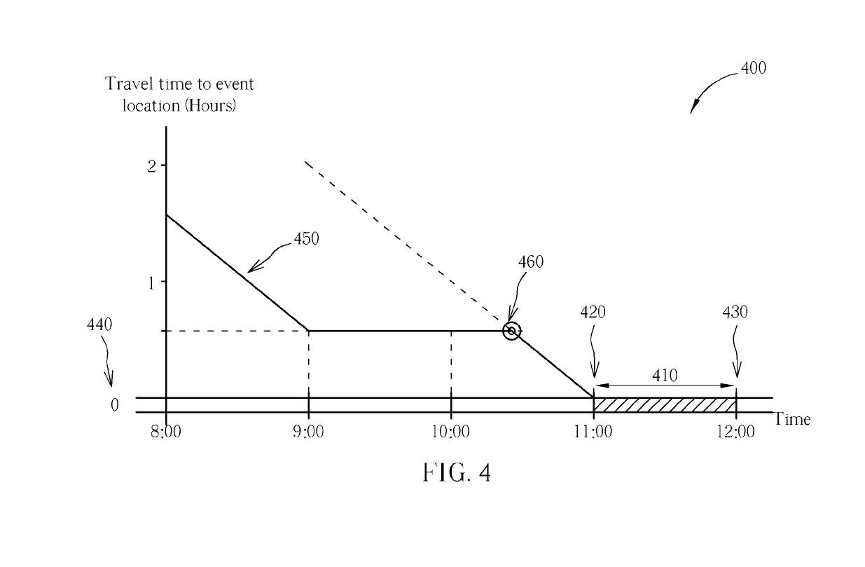

Let's briefly refer to FIG. 4. In contrast to the “one-dimensional” calendar as illustrated in FIG. 2, FIG. 4 is a graph showing an exemplary event for a “two-dimensional” calendar according to an embodiment of the present invention. In graph 300 of FIG. 4, the horizontal axis indicates a timeline from 8:00 am to 12:00 pm, and shows an event 410 with a start time 420 of 11:00 am and an end time 430 of 12:00 pm. The vertical axis shows the remaining travel time needed to get to the event location 410, and units of this axis in this graph 400 are shown in hours, with the zero-crossing being where the event location 440 is. The line 450 tracks the position of the user over time, compared to how long it would take the user to travel to the event location 440. An example of the user's morning travels is plotted with line 450, and from the graph 400, we can see that since 9:00 am, the user has been in substantially the same distance or time from the 11:00 am meeting; the user is about one-half hour from the 11:00 am event. According to the traditional calendar of FIG. 2, the event 210 scheduled with an alarm at 10:45 am would still only notify the user of the 11:00 am meeting at 10:45 am, regardless of the user's distance (or time) away from the event location 440. From the graph 400 while using a traditional calendar system, the user would be late for the meeting if notified 15 minutes beforehand, if he were 30 minutes away. Clearly, the acceptable notification time would be 30 minutes ahead (10:30 am, indicated at point 460 in FIG. 4), allowing the user to travel to the event location immediately upon receiving the notification.

One should note here that reminding the user in Step 340 occurs “at least the travel time before the event time”. Step 340 of the method presented in FIG. 3 allows, in one exemplary embodiment, the notification to be set at least the travel time and a predetermined warning time before the event time. For instance, using the above scenario once more, the notification can be set at 15 minutes before the travel time required; for the 11:00 am event 410 needing 30 minutes of travel (indicated by point 460 in FIG. 4), the notification would occur at 10:15 am. The 15 minutes “warning time” could be used to allow the user to wrap up a previous meeting or event, or to make his way to his car, call a taxi, or prepare for the next meeting (at 11:00 am). This warning time could be set manually by the user, or could also be adapted from various other factors, such as weather conditions, traffic information, etc.

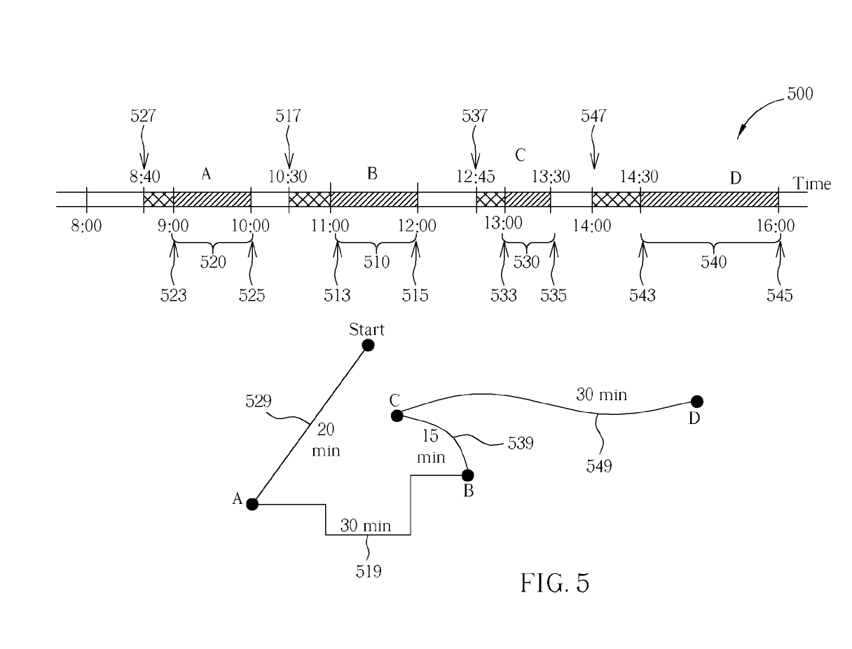

Please refer now to FIG. 5. FIG. 5 is a diagram 500 depicting various exemplary locations of events according to a schedule in an embodiment of the present invention. Here, four example events 510, 520, 530, 540 are scheduled with respective start times 513, 523, 533, 543 and respective end times 515, 525, 535, 545. Additionally, the events 510, 520, 530, 540 have respective notifications 517, 527, 537, 547 based on the travel times required to reach each of the events (along the routes 519, 529, 539, 549, respectively). Looking at one of the events in more detail, the event 510 (also denoted as B) has a start time 513 of 11:00 am and an end time 515 of 12:00 pm. The scheduling method has determined the user position prior to the event 510 is the location of event 520 (or A), and has calculated the required travel time to be 30 minutes. As a result, the user will be notified of the event 510 at least 30 minutes before the start time of the event 510: this is marked in FIG. 5 by notification 517 at 10:30 am. Likewise, the events 520, 530, and 540 (noted A, C, and D) are processed in the same way according to this method of the present invention.

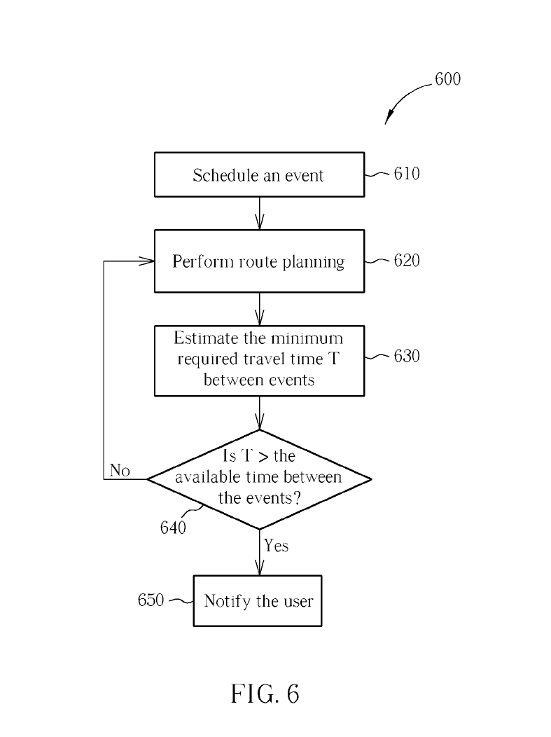

In yet another embodiment of a method of the present invention, the method includes a step for checking if the event schedule is feasible (i.e., if the event locations are reachable on time). Once the travel time required for each event is calculated, the method includes a process for checking whether the travel time for each event exceeds the unscheduled (“free”) time before it. Delving a little deeper into this part of the method, please refer to FIG. 6. FIG. 6 is a flowchart of a calendar spatial check according to one embodiment of the present invention.

Recall that provided that substantially the same result is achieved, the steps of the process flowchart 600 need not be in the exact order shown and need not be contiguous; that is, other steps can be intermediate. The steps for each event to be scheduled are as follows:
Step 610: Schedule an event.
Step 620: Perform route planning based on user profile or default setting.
Step 630: Estimate the required travel time T between events.
Step 640: Compare the required travel time T against the available time between the events. Conflict?
Step 650: Notify the user of possible schedule conflict.

Following the steps laid out above, Step 610 begins by scheduling an event having an event time and an event location. To be useful, Step 610 requires at least one event to be scheduled; two is better, as we shall see below. Step 620 performs route planning (using a strategy based upon the user's profile, history experience, and/or default setting), utilizing the event location as the start point and the location of the event immediately succeeding this event as the end point; that is, from “this event” to the next one. According to these start and end points, Step 630 estimates the required travel time T between the events, which is then compared against the available time between the event and the succeeding event in Step 640. The time available between “this event” and the next is defined by the time duration between the end time of the current event and the start time of the following event. The goal of Step 640 is to determine whether a possible schedule conflict exists, so when the result from this is that T is greater, the process proceeds to Step 650; when T is lower, it instead continues to process the next event (as applicable). In Step 650, the user is notified of a possible schedule conflict.

A realistic example is now presented. Using the schedule of FIG. 5 again, let's look at event 530 (C) and assume that the travel time from the location of event 510 (B) to the location of event 530 (C) requires 75 minutes of driving. Since the start time of event 530 (at 1:00 pm) is only 60 minutes after the end time of event 510 (ending at 12:00 pm), the method determines there is insufficient time to make it to event 530. At this point, a notification is brought to the user indicating a possible “scheduling conflict” due to the travel time. Please note that other examples and extensions are also possible: for instance, in a different embodiment, such a notification may come up even if the travel time is less than 60 minutes, but the user's historical travel patterns indicate that he or she usually takes an additional 20 minutes over the estimated travel times to arrive at given destinations. In this adaptation of the previous method of the present invention, “unreasonable” or “impossible” schedules can be brought to the attention of the user for correction (or be overridden).

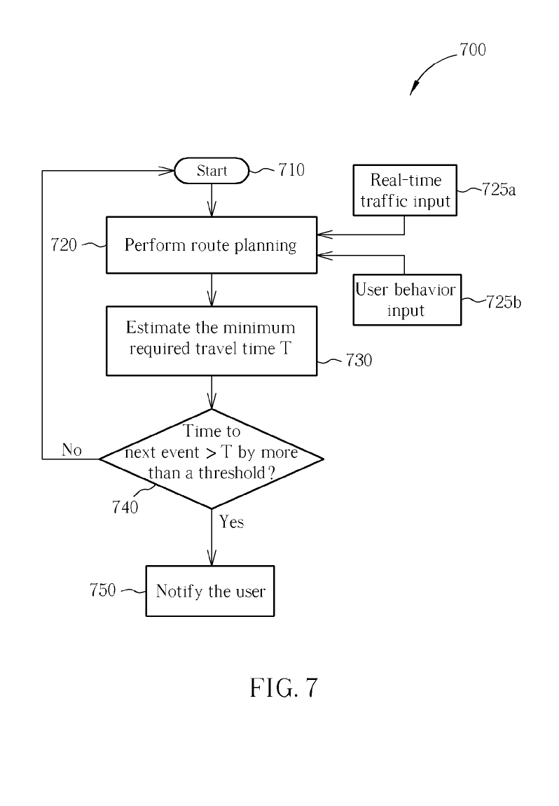

Similarly, examining a particular step closer, FIG. 7 is a flowchart of a calendar real-time alarm check according to one embodiment of the present invention. As before, the steps can be rearranged, combined, interlaced with additional steps; as long as the achieved result is substantially the same, it should be considered within the scope of this invention. The steps to perform at each time interval for notifying the user are as follows:
Step 710: Start.
Step 720: Perform route planning, utilizing the current position of the user as the start point and the event location as the end point.
Step 730: Estimate the required travel time T to arrive at the event location, according to the start point and the end point.
Step 740: Compare the required travel time T against the available time until the event. When the available time to the next event is greater than T by more than a predetermined threshold, proceed to Step 650; when it's not, continue to checking the next event.
Step 750: Notify the user.

At each predetermined time interval, the real-time alarm process is started with Step 710. This time interval can be determined internally to the device, or can be set or configured by the user (i.e., every 5 minutes, 30 minutes, or every hour, etc.): there will be, however, power consumption versus convenience tradeoffs for such a selection, of course. In Step 720, the process performs route planning by utilizing the current position of the user as the start point and the event location as the end point. Step 720 can optionally receive real-time traffic information (725a) and user preferences information (725b), as was previously described, and additional scheduling factors (such as shortest-time restrictions for planning the route) can also be considered in planning the route. According to the start point and the end point and the planned route between them, Step 730 estimates the required travel time T to arrive at the event location. In Step 740, the required travel time T is compared against the available time until the event. When the available time to the next event is greater than T by more than a predetermined threshold—for example, when there are still 45 minutes to the next event, and it takes 33 minutes to get there, and the predetermined threshold is 15 minutes—then the method proceeds to Step 650. When it's not (e.g., when the travel time needed and the warning time before that have not approached yet), the method continues to check the notification time for the next event (as applicable). Step 750 is simply the step of notifying the user of the upcoming event.

Please note that in a different embodiment of the above process, Steps 710 and 720 can be done well in advance of the real-time check, and could be performed just one time. In contrast, then, only Steps 730 and 740 (and possibly Step 750) would be done periodically, as necessary (or as configured by the user) to maintain accurate and up-to-date alarm/notification information.

In a related approach to the first methods (described above) of the present invention, the scheduling method provides additional intelligence and processes the schedule further on behalf of the user. Referring back to FIG. 5, the mentioned method of the present invention evaluates the locations of the events within a given time span (say, each day from midnight to midnight). In another embodiment, the method further determines an order of those events according to at least one scheduling factor. For example, given the events 510, 520, 530, and 540 from FIG. 5, the method plans an order for those events (and subsequently, a route for that day) based on a number of factors. The scheduling factor could, for instance, comprise a total travel time required between the events over the day (that is, within a predetermined period), based on the event location of each event. In essence, such a scheduling consideration could determine a more optimal route for the same event locations. The scheduling factor could take into consideration having multiple restaurants en route, or having the user's favorite gas station nearby. In another example, the scheduler suggests a suggested event time (start time) for each event according to the order of events and the scheduling factor(s), which the user may accept override. Other scheduling factors are possible, of course, and should be considered within the scope of this invention.

After reviewing these first embodiments of the present invention, other applications and implementations will be obvious to those skilled in the art, and should be included within the scope of the present invention.

Please note that although the current examples have shown meetings and daily schedules, this is only intended for clarity of explanation and is not meant as a limitation to the present invention: the present invention can be applied to any scheduler, organizer, or calendar which schedules events (even multi-day events) and such applications and embodiments also obey the spirit of and should be considered with the scope of the present invention.

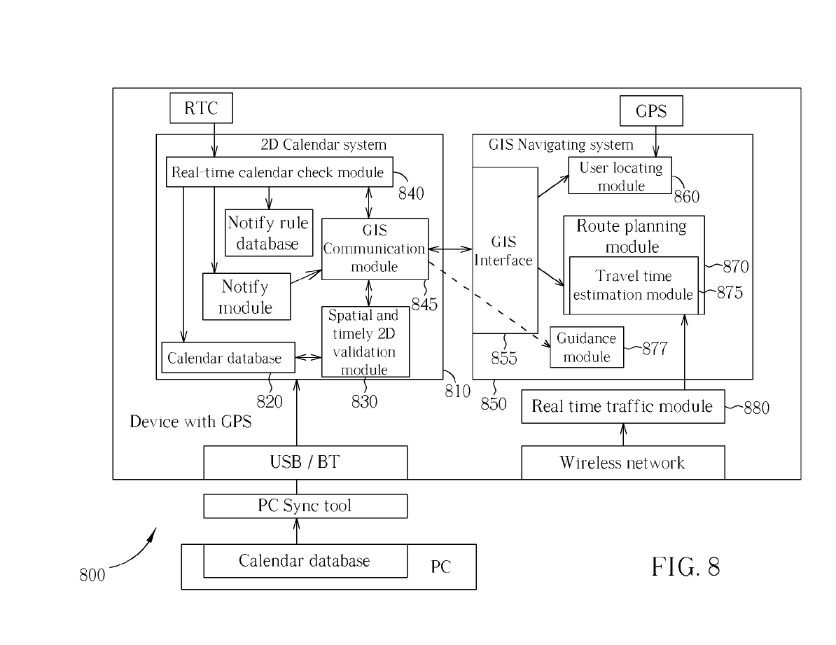

A scheduling system of the scheduling method previously described is shown in FIG. 8, which is a system block diagram illustrating an exemplary “two-dimensional” calendar system according to an embodiment of the present invention. The scheduling system 800 comprises a two-dimensional (2D) calendar system 810 and a geographic information system (GIS) navigating system 850. The 2D calendar system 810 comprises a calendar database 820, a spatial and temporal 2D validation module 830, and a real-time calendar check module 840. The calendar database 820 is for scheduling a plurality of events, each event having a respective event time and event location (as disclosed earlier), the spatial and temporal 2D validation module 830 is for calculating a travel time required before each event according to the respective event location of each event and the position of the user prior to each event, and the real-time calendar check module 840 is for reminding the user of each event at least the travel time before each event. On the right of the block diagram in FIG. 8, the GIS navigating system 850 is for determining a position of the user prior to each event, and comprises a user locating module 880, a route planning module 870 (encompassing a travel time estimation module 875), and a real-time traffic module 880. Two other components are also shown in FIG. 8: a GIS communication module 845 and a GIS interface 855.

Please note that although many components and modules are presented in this example system block diagram, it is an arbitrary selection for illustration purposes only and is not intended to be a limitation to the present invention. Additional components can be interconnected, some components integrated or combined into other components, or omitted altogether; these variations on the above should be considered within the scope of this present invention, provided they achieve at least substantially the same functions and features. Further optional descriptions and suggestions for the components follow below.

For instance, as was mentioned before, the position of the user can be determined by a GIS navigating system (as marked by the GIS communication module 845 and GIS interface 855), which can be a GPS unit (shown in FIG. 8, but not marked). The guidance module 877 is optional here, but is normally included in GIS systems of today, and real-time traffic information is commonly available through the real-time traffic module 880. The other components shown (though not numbered) in FIG. 8 illustrate additional alternatives and examples: a PC sync tool is meant to be a generic transfer/exchange mechanism between the calendar system 800 and another device such as a PC, for example.

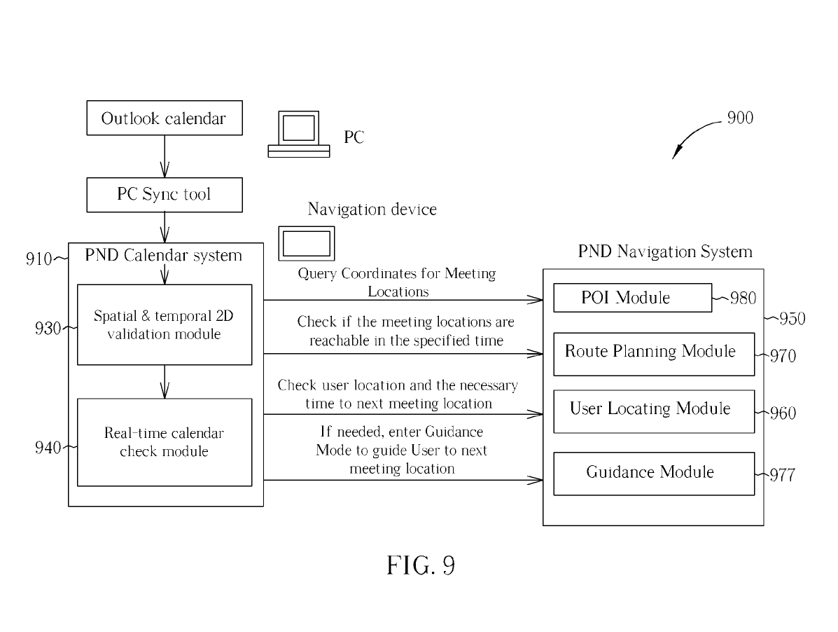

In another view of the scheduling system according to an embodiment of the present invention, FIG. 9 is a block diagram illustrating an example process. The scheduling system 900 comprises a personal/portable navigation device (PND) calendar system 910 and a PND navigation system 950. The PND calendar system 910 includes a spatial and temporal 2D validation module 930 and a real-time calendar check module 940, whereas the PND navigation system 950 includes a point of interest (POI) module 980, a route planning module 970, a user locating module 960, and a guidance module 977. The majority of these modules and their functions have been previously described and therefore will not be repeated here.

The PND calendar system 910 is for querying the POI module 980 for location information (such as coordinates) on the locations of scheduled events. The spatial and temporal 2D validation module 930 is for performing steps (example shown in FIG. 6), for determining the predefined notification time for each event, utilizing the route planning module 970 as input to checking if the event locations are reachable within the available time (i.e., between scheduled events). As before, the spatial and temporal 2D validation module 930 (which is similar to the spatial and temporal 2D validation module 830) may calculate the travel time according to a user profile specifying travel preferences for the user, and additionally can utilize historical user data including how long the user required to travel to events in the past. The real-time calendar check module 940 is for performing the steps (as shown in FIG. 7) for checking if notifications should be made to the user based on the latest available information, and utilizes the user location module 960 and guidance module 977 as necessary to assist the user. The real-time calendar check module 940 is substantially the same as the real-time calendar check module 840 of FIG. 8, for reminding the user of each event at least the travel time and a predetermined warning time before each event time.

It should be noted here that, this embodiment can be combined with one of the embodiments above such that the spatial and temporal 2D validation module 930 determines an order of the events according to at least one scheduling factor, and for automatically scheduling the events according to the determined order of events. In such a case, the scheduling system 900 then suggests or schedules events according to the locations of the events entered, and recommends a route for the user.

Also, although the present invention and its advantages have been described in detail so far, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Those skilled in the art will readily observe that numerous modifications and alterations of the device and method may be made while retaining the teachings of the invention.

What is claimed is:

1. A method of event scheduling, the method comprising:
scheduling an event having an event time and an event location;
determining a position of the user prior to the event;
calculating a travel time required before the event according to the event location and the position of the user prior to the event; and
reminding the user according to the travel time before the event time.

2. The method of claim 1, wherein the position of the user prior to the event is a current location of the user determined by a Global Navigation Satellite System (GNSS) device.

3. The method of claim 1, wherein calculating the travel time is performed according to real-time traffic information.

4. The method of claim 1, wherein calculating the travel time is performed according to a user profile specifying travel preferences for the user.

5. The method of claim 1, wherein calculating the travel time is performed according to historical user data including how long the user required to travel to events in the past.

6. The method of claim 1, further comprising reminding the user of the event at least the travel time and a predetermined warning time before the event time.

7. The method of claim 1, further comprising:
scheduling a plurality of events, each event having a respective event time and event location;
determining a position of the user prior to each event;
calculating a travel time required before each event according to the respective event location of each event and the position of the user prior to each event; and
reminding the user of each event according to the travel time before each event.

8. The method of claim 7, wherein the position of the user prior to each event is the event location of a previous event.

9. The method of claim 7, further comprising:
determining an order of the events according to at least one scheduling factor;
automatically scheduling the events according to the determined order of events; and
reminding the user according to the travel time of each event.

10. The method of claim 9, wherein the scheduling factor comprises a total travel time required between the events within a predetermined period according to the event location of each event.

11. The method of claim 9, further comprising scheduling a suggested event time for each event according to the order of events and the at least one scheduling factor.

12. A scheduling system comprising:
a calendar database for scheduling a plurality of events, each event having a respective event time and event location;
a GIS navigation system for determining a position of the user prior to each event;
a spatial and temporal 2D validation module for calculating a travel time required before each event according to the respective event location of each event and the position of the user prior to each event; and
a real-time calendar check module for reminding the user of each event according to the travel time before each event.

13. The system of claim 12, wherein the position of the user prior to each event is the event location of a previous event.

14. The system of claim 12, wherein the position of the user prior to each event is a current location of the user determined by the GIS navigation system.

15. The system of claim 12, wherein the spatial and temporal 2D validation module further calculates the travel time according to real-time traffic information.

16. The system of claim 12, wherein the spatial and temporal 2D validation module further calculates the travel time according to a user profile specifying travel preferences for the user.

17. The system of claim 12, wherein the spatial and temporal 2D validation module further calculates the travel time is performed according to historical user data including how long the user required to travel to events in the past.

18. The system of claim 12, wherein the real-time calendar check module further reminds the user of each event at least the travel time and a predetermined warning time before each event time.

19. The system of claim 12, wherein the spatial and temporal 2D validation module is further for determining an order of the events according to at least one scheduling factor, and for automatically scheduling the events according to the determined order of events.

20. The system of claim 19, wherein the scheduling factor comprises a total travel time required between the events within a predetermined period according to the event location of each event.

21. The system of claim 19, wherein the spatial and temporal 2D validation module is further for scheduling a suggested event time for each event according to the order of events and the at least one scheduling factor.
